(19) United States
(12) Patent Application Publication
(10) Pub. No.: US 2025/0360053 A1
(43) Pub. Date: Nov. 27, 2025

(54) VIBRATION UNIT FOR STIMULATING AN ACUPRESSURE POINT

(71) Applicant: ease GmbH, Bad Abbach (DE)

(72) Inventors: Dominik SANTL, Pfakofen (DE); Paulina KAISER, Regensburg (DE)

(21) Appl. No.: 19/295,158

(22) Filed: Aug. 8, 2025

Related U.S. Application Data
(63) Continuation of application No. PCT/EP2024/053306, filed on Feb. 9, 2024.

(30) Foreign Application Priority Data
Feb. 10, 2023 (DE) 10 2023 103 316.6

(51) Int. Cl. A61H 39/00

(52) U.S. Cl. CPC A61H 39/007; A61H 2201/0153; A61H 2201/1207; A61H 2201/5025; A61H 2201/5035; A61H 2201/5043

(57) ABSTRACT

A vibration unit for stimulating an acupressure point is disclosed. The vibration unit has an energy storage device and a motor with a control electronics unit arranged in the interior. Furthermore, a chain is attached to a head of the vibration unit in order to adapt the vibration unit to the acupressure point, also known as CV 17. Various modes consisting of power levels and assigned frequencies can be set using at least one push button.

### CROSS-REFERENCE TO RELATED APPLICATIONS

This application is the U.S. national stage application filed pursuant to 35 U.S.C. 365(c) and 120 as a continuation of International Patent Application No. PCT/EP2024/053306, Feb. 9, 2024, which application claims priority to German Patent Application No. DE 102023103316.6, filed Feb. 10, 2023, which applications are incorporated herein by reference in their entireties.

### FIELD OF THE INVENTION

The invention relates to a vibration unit for stimulating an acupressure point, in particular CV 17 (also known as Ren 17). For this purpose, at least one energy storage device and a motor with a control electronics unit are arranged inside the vibration unit.

### BACKGROUND

German utility model DE 20 2012 003 151 U1 relates to a vibrating therapy pen with a housing that is detachably connected to an interchangeable therapy tip. The therapy tip comprises an eccentric and an electric motor that are connected to form a unit. The therapy pen must be placed by hand onto the area of the body to be treated.

German patent application DE 10 2004 032 606 A1 discloses a massage and healing device for applying alternating pressure to limited areas of the skin and the underlying tissue, either in a stationary or mobile manner. The device consists mainly of a first massage body, which is essentially spherical or egg-shaped and whose surface forms a large massage area, and a second massage body that is essentially rod-shaped with an elongated shaft and two ends, one end of which has a first end piece for connection to a complementarily designed connecting piece on the first massage body and the second end of which has a second end piece for massaging with a curved small massage surface. Here too, the massage and healing device must be placed by hand onto the area of the body to be treated and moved accordingly for the massage.

German patent application DE 198 52 608 A1 relates to a device, in particular a hand-held device, for vibration therapy for treating primarily the muscles and the skeletal structure. The device transmits a tumbling motion of the oscillating head when the drive shaft rotates by forming an angle between the drive shafts of the oscillator and the oscillating head. The device is compact, lightweight, and wear-resistant, and can be manufactured inexpensively. The device must be placed by hand onto the area of the body to be treated.

German patent application DE 197 09 355 A1 relates to an acupressure stick with a built-in ball arrangement consisting of a freely rotatable main ball and a ball ring surrounding this main ball with freely rotatable smaller balls. The acupressure stick must be placed by hand onto the area of the body to be treated.

German patent application DE 10 2008 057 479 A1 discloses a device and method for strengthening the immune system through long-term stimulation of the thymus gland. The device for thermal, electrical, electromagnetic, and mechanical stimulation of the thymus gland is shown, for example, as a pendant with a necklace. When assembled, the pendant encloses the vibrating motor in a cover and the electronics in an intermediate piece. There is no visual indicator (display) of the set intensity and/or frequency.

The website https://de.aliexpress.com/item/1005003408412266-html discloses a metal vibrator that can be charged via a USB interface. There is no visual indicator (display) of the vibration setting (intensity and/or frequency).

The website https://de.aliexpress.com/item/1005004489043127.html discloses a powerful ball vibrator that can be worn as a necklace. There is no visual indicator (display) of the set intensity and/or frequency. The website https://www.amazon.de/Crave-E25572-Vesper-Vibrator-silberfarben/dp/BOOPR3QK3G?th=1 offers a silver-colored vibrator that can be worn on a necklace. There is no visual indicator (display) showing the vibration setting (intensity and/or frequency).

The website https://www.etsy.com/at/listing/1414174361/1 Ox-vibrierende-silikon-herz-halskette discloses a vibrating silicone heart. There is no indication of how the vibration is set (intensity and/or frequency).

The prior art includes treatment methods, e.g., for situational nervousness or agitation, which use relaxation techniques, medication and/or therapies to control nervousness or agitation.

The concept is based on the method of acupressure, whereby pressure is applied to specific acupressure points using the fingers or a device to reduce stress and increase well-being. This healing method has the advantage that it is easy to use, has no side effects, and helps users to perform at their best.

### SUMMARY OF THE INVENTION

The object of the invention is therefore to provide a vibration unit for stimulating an acupressure point that is easy to use at any time, with simple adjustment of the vibration unit and clear indication of the setting selected.

This object is solved by a vibration unit for stimulating an acupressure point. The vibration unit has a cylindrical shaft, defining an interior for accommodating at least an energy storage device and a motor with an electronics control unit. A detachable head which is attached to the cylindrical shaft by means of a thread and closes the cylindrical shaft opposite a free end. A push button is provided on the cylindrical shaft of the vibration unit, wherein the push button is for switching on and off and for setting power levels and a vibration frequency of the vibration unit associated with the power levels is provided. A visual indicator is on the shaft of the vibration unit, wherein the visual indicator displays the set power levels and the set associated vibration frequency. A chain is attached to the head of the vibration unit for positioning the vibration unit on the acupressure point.

In one embodiment, the vibration unit comprises a cylindrical shaft in which an energy storage device and a motor with a control electronics unit are housed. The cylindrical shaft carries a detachable head, with the shaft being closed at a free end opposite the head. At least one push button is provided on the cylindrical shaft of the vibration unit, which serves to switch the vibration unit on and off and to set power levels and the frequency of vibration (vibration frequency) of the vibration unit associated with the power levels. Furthermore, a visual indicator (display) is provided on the shaft of the vibration unit to indicate the set power levels and the set associated vibration frequency. A chain is attached to the head of the vibration unit to position the vibration unit on the acupressure point.

The advantage of the invention is that it provides a simple means of stimulating an acupressure point, which can be used at any time as required. Furthermore, the vibration unit according to the invention has the advantage that, during use, the user can clearly recognize the set power level and the corresponding set power.

According to one possible embodiment of the invention, the at least one push button is designed as a rocker switch to switch the power levels and the associated vibration frequency of the vibration unit up and down.

The advantage of this embodiment is that the push button for setting the power level (intensity level) and the associated vibration frequency is accessible at any time, even when the device is being worn. For example, the push button can be used to select several (preferably three) constant power levels of the motor (vibration motor) over time, namely low, medium, and high, as desired and required. The push button can also be used to select or set different frequencies and pulse shapes for the vibration of the motor.

The advantage is that the vibration and the vibration frequency can thus be adjusted to the user's needs.

According to one possible embodiment, the visual indicator is divided into several sections. Each of the sections represents one of the power levels possible with the vibration unit. Each of the power levels defines a different power level, whereby several different vibration frequencies can be set for each power level. The same set of different vibration frequencies can be set for each of the power levels.

According to one embodiment, the visual indicator is divided into three sections. This means that three power levels can be implemented and displayed, which the user of the vibration unit can read easily and reliably. Consequently, as already mentioned above, the three same but different vibration frequencies can be set in each power level.

Three frequencies are preferred in each of the three power levels, such as 1 Hz, 7.83 Hz, and 12.13 Hz, which can be set using the push button. The three power levels together with the three adjustable frequencies thus result in nine modes, which are stored in the control electronics unit. With the three power levels, the three frequencies always run through one after the other. At the first power level, modes 1-3 can be set, whereby 1 Hz can be set first, then 7.83 Hz and finally 12.13 Hz. At the second power level, modes 4-6 can be set with frequencies of 1 Hz, then 7.83 Hz and finally 12.13 Hz. At the third power level, modes 7-9 can be set with frequencies of 1 Hz, then 7.83 Hz and finally 12.13 Hz.

The frequencies therefore always remain fixed, but the vibration changes.

The advantage of being able to adjust and read the power levels and the corresponding frequencies is that the user can select the setting that suits him best and also reliably check the setting he has selected.

According to a further embodiment, the head is detachably formed from the shaft of the vibration unit. A charging cable can be connected to the shaft to charge the energy storage device of the vibration unit via a power source. This design has the advantage that possible damage to the connection for the charging cable inside the shaft is avoided.

According to a further embodiment, at least the shaft of the vibration unit is made of stainless steel with a nickel-free outer coating. This has the advantage of preventing allergies.

According to a possible embodiment, a design element is detachably attached to the cylindrical shaft of the vibration unit. The attached design element is positioned on the cylindrical shaft in such a way that the at least one push button is accessible, and the visual indicator is readable.

According to a further possible embodiment of the invention, a design element can be detachably attached to the cylindrical shaft of the vibration unit. The design element is made of an elastic material and an elastic material strip is attached to the rear side of the design element. This allows the vibration unit to be held in a detachable and force-fitting manner between the rear side of the design element and the material strip. Preferably, the material of the design element and the material of the material strip are identical.

According to a further embodiment of the invention, the material of the design element and the material strip are configured in such a way that it is washable.

The advantage of the detachable and force-fitting mounting of the vibration unit between the rear of the design element and the material strip is that the design element can be replaced. Furthermore, the vibration unit can be removed for cleaning the design element in order to protect the electronic components inside the vibration unit from moisture.

According to a preferred embodiment, the material of the design element and the material strip is silicone. Silicone is a material that is often used for medical devices and products due to its special properties. It is easy to maintain and washable and is therefore considered very hygienic.

One possible form of the design element is a feather which, together with the material strip, serves as a silicone cover for the vibration motor. The feather should be between 8 cm and 10 cm long and 3 cm to 5 cm wide.

According to a further embodiment of the invention, the chain attached to the head of the vibration unit is dimensioned such that when the vibration unit is used, it comes to rest on an acupressure point, CV 17, of the user. The optimum length of the chain is 50 cm to 60 cm and can be adjusted according to the user's wishes and anatomical conditions.

According to a further possible embodiment of the invention, the head can be removed from the shaft of the vibration unit in order to connect a charging cable to the shaft. This allows the energy storage device of the vibration unit to be recharged. The energy storage device has a battery life of approximately 40 minutes, which is sufficient for two applications of the vibration unit. The charging cable has a USB connection adapter, and the charging time is approximately 1 hour and 30 minutes.

The material of the vibration unit is not limited to stainless steel or stainless steel with a coating. The material of the vibration unit should be such that it transmits the vibrations of the motor inside the vibration unit without damping. The vibration unit can also be provided with different coatings. The shape of the vibration unit is not limited to a cylindrical shape. The material of the design element and that of the material strip may be different, provided that the condition is met that the vibration unit is detachably held in a force-fitting manner on the design element. With one vibration unit, different design elements can be sold as a set, for example, so that they can be exchanged at any time according to the user's wishes.

The invention and its advantages are now explained in more detail with reference to the accompanying drawings, without limiting the invention to the embodiment shown. The proportions in the figures do not always correspond to the actual proportions, as some shapes have been simplified and others enlarged in relation to other elements for the sake of clarity.

### BRIEF DESCRIPTION OF THE DRAWINGS

FIG. 1 shows a person wearing the device for stimulating the acupressure point CV 17 (master point);

FIG. 2 shows a schematic cross-sectional view of the vibration unit along the length of the vibration unit;

FIG. 3 shows a possible embodiment of the vibration unit for stimulating an acupressure point;

FIG. 4 shows a head removed from the vibration unit;

FIG. 5 shows a possible embodiment of the visual indicator of the vibration unit, wherein a power level is set with an associated vibration frequency;

FIG. 6 shows a possible embodiment of the visual indicator of the vibration unit from FIG. 5, wherein a different power level is set with the associated vibration frequency.

FIG. 7 shows a possible embodiment of the visual indicator of the vibration unit from FIG. 5, wherein a further power level is set with the associated vibration frequency;

FIG. 8 shows another possible embodiment of the visual indicator of the vibration unit, wherein a power level is set with an associated vibration frequency;

FIG. 9 shows a possible embodiment of the visual indicator of the vibration unit from FIG. 8, wherein a different power level is set with the associated vibration frequency;

FIG. 10 shows a possible embodiment of the visual indicator of the vibration unit from FIG. 8, wherein a further power level is set with the associated vibration frequency;

FIG. 11 shows a possible embodiment of the vibration unit for stimulating the acupressure point, wherein a design element is attached to the vibration unit;

FIG. 12 shows a possible embodiment of the design element for the vibration unit;

FIG. 13 shows a side view of the vibration unit inserted into the design element;

FIG. 14 shows a schematic sectional view along the section line A-A shown in FIG. 6;

FIG. 15 shows a charging cable connected to the vibration unit;

FIG. 16 shows a possible embodiment of the vibration power setting with which the stimulation is performed, and,

FIG. 17 shows a possible embodiment of the vibration frequency profile for a specific power level with which the stimulation is performed.

### DETAILED DESCRIPTION OF THE INVENTION

Identical reference symbols (numerals) are used for identical or equivalent elements of the invention. Furthermore, for the sake of clarity, only reference symbols that are necessary for the description of the respective figure are shown in the individual figures. The figures merely represent embodiments of the invention, without limiting the claims to the embodiments shown.

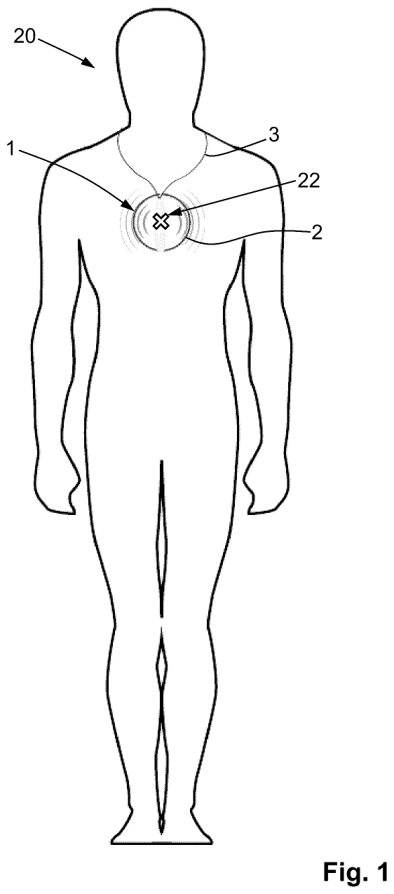

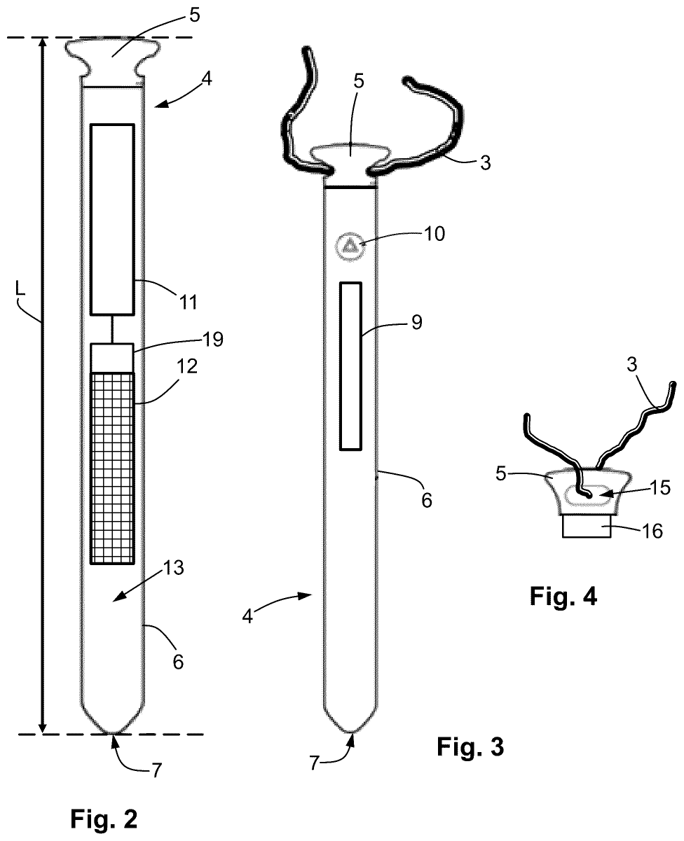

FIG. 1 shows a user 20 wearing the device 1 for stimulating an acupressure point 22. In the illustration shown here, the acupressure point 22 to be stimulated by device 1 is CV 17. Device 1 for stimulation is worn by means of a chain 3. In the embodiment shown here, the stimulation device 1 consists of a design element 2 and a vibration unit 4 (see, for example, FIG. 2 or FIG. 3). Chain 3 is dimensioned or can be adjusted in such a way that the vibration unit 4 of stimulation device 1 rests on the acupressure point 22 (CV 17 or master point).

FIG. 2 shows a schematic sectional view of vibration unit 4 along the length L of vibration unit 4. In the interior 13 of shaft 6 of vibration unit 4, which is closed by a head 5, there is an energy storage device 11 connected to a motor 12 designed as a vibration motor. Energy storage device 11 is a rechargeable battery. Motor 12 is an electric motor. Activation of motor 12 triggers a vibration or a control electronics unit 19, which causes a vibration pattern or an intensity of the vibration of vibration unit 4.

FIG. 3 shows an exterior view of a possible embodiment of vibration unit 4. A cylindrical shaft 6 of vibration unit 4 can be closed at one end with a head 5. Chain 3 is guided through head 5. Shaft 6 is closed at a free end 7 opposite head 5. Free end 7 of shaft 6 is rounded. In the embodiment shown here, shaft 6 is provided with at least one push button 10 near head 5. Vibration unit 4 can be switched on and off via the at least one push button 10. The intensity level of the vibration and/or a profile (frequency) of the vibration can also be set via the at least one push button 10. According to the embodiment shown here, shaft 6 of vibration unit 4 is provided with at least one visual indicator 9 (display), via which the at least one set intensity level of the vibration and/or a profile (frequency) of the vibration can be read.

FIG. 4 shows a head 5 removed from vibration unit 4. Head 5 can be connected to vibration unit 4, for example, via a thread 16. As shown in FIG. 15, a charging cable 17 connected to the vibration unit 4 can be connected to head 5 removed from vibration unit 4. In the illustration shown in FIG. 15, design element 2 is still attached to vibration unit 4. A material strip 14 secures vibration unit 4 to the design element 2 in a removable manner.

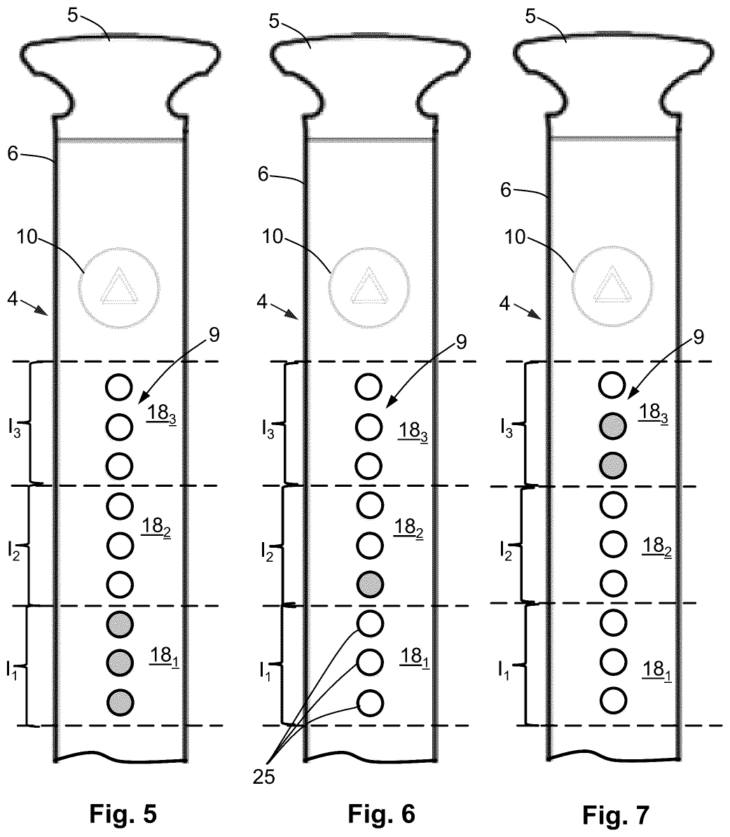

FIG. 5 shows a possible embodiment of the visual indicator 9 of vibration unit 4. In the embodiment shown here, visual indicator 9 is divided into three sections 18₁, 18₂, and 18₃. Visual indicator 9 formed on shaft 6 comprises several LEDs 25. In the representations of the vibration unit 4 shown in FIGS. 5 to 7, the embodiment of visual indicator 9 comprises nine LEDs 25, with three LEDs 25 representing one of the three power levels I₁, I₂, or I₃. The pressure head 10 can be used to set the power levels I₁, I₂, or I₃ with an assigned vibration frequency. In the illustration in FIG. 5, the first power level Ii is set with the third vibration frequency of vibration unit 4. As can also be seen from the illustrations in FIGS. 5 to 7, each of the three power levels I₁, I₂, or I₃ comprises three LEDs 25. Each LED 25 of the three power levels I₁, I₂, or I₃ represents three different frequencies. The lower LED 25 represents a frequency that is lower than a frequency indicated by the middle LED 25, and this frequency is lower than the frequency indicated by the upper LED 25. In the vibration unit 4 shown in FIG. 5, the first power level I₁ is set to the highest frequency, since all three LEDs 25 of the first section 18₁ light up for power level I₁. For the sole purpose of describing the functionality of vibration unit 4, three power levels I₁, I₂, or I₃ are used, each with three different frequencies. It is obvious to a person skilled in the art that a restriction to three power levels I₁, I₂, or I₃ with three frequencies each, used for descriptive purposes, cannot be understood as a limitation of the invention.

FIG. 6 shows a possible embodiment of visual indicator 9 of vibration unit 4 from FIG. 5, wherein the second power level I₂ with the lowest vibration frequency of vibration unit 4 is set via the push button 10.

FIG. 7 shows a possible embodiment of visual indicator 9 of vibration unit 4 from FIG. 5, wherein the third power level I₃ is set to the middle vibration frequency of vibration unit 4 via the push button 10.

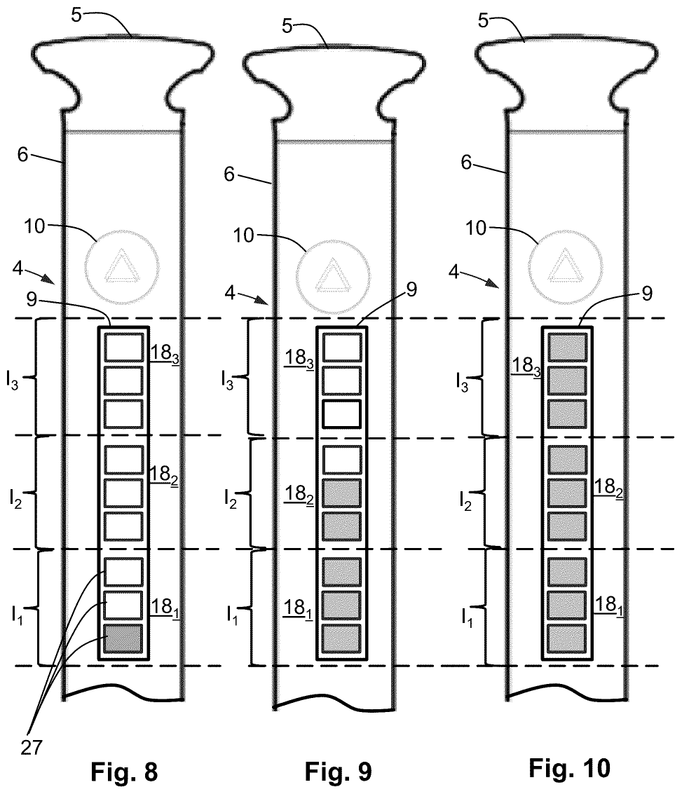

FIG. 8 shows another possible embodiment of visual indicator 9 of vibration unit 4. Here, a power level with an assigned vibration frequency is set. Visual indicator 9 formed on shaft 6 is, for example, a visual indicator which, in the possible embodiment described here, is divided into three sections 18₁, 18₂ and 18₃. As in the embodiment described in FIG. 5, the three power levels I₁, I₂ or I₃ of vibration unit 4 are set in an analogous manner. Visual indicator 9 comprises a plurality of visual indicator elements 27 (display elements). In the embodiment described here, visual indicator 9 has nine visual indicator elements 27 which together define three power levels I₁, I₂ or I₃. In the illustration shown in FIG. 8, the first power level I₁ with the lowest frequency is set using the push button 10.

FIG. 9 shows a possible embodiment of visual indicator 9 of vibration unit 4 from FIG. 8, wherein the second power level I₂ with the medium vibration frequency of vibration unit 4 is set via the push button 10.

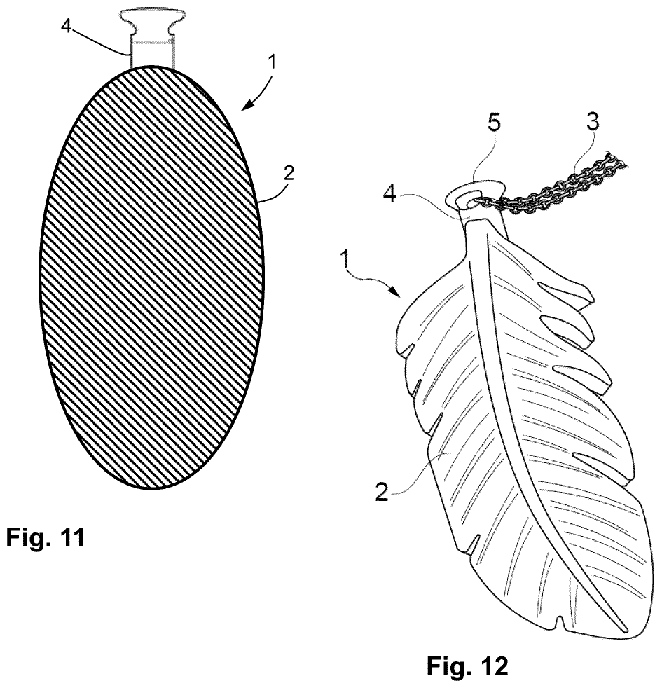

FIG. 10 shows a possible embodiment of visual indicator 9 of vibration unit 4 from FIG. 8, wherein the third power level I₃ with the highest vibration frequency of vibration unit 4 is set via the push button 10.

It is obvious to a person skilled in the art that visual indicator 9 designed as a display can also be designed as an alphanumeric visual indicator or alphanumeric visual display to inform the user about the set power levels I₁, I₂, . . . , I_{N} with the corresponding frequencies.

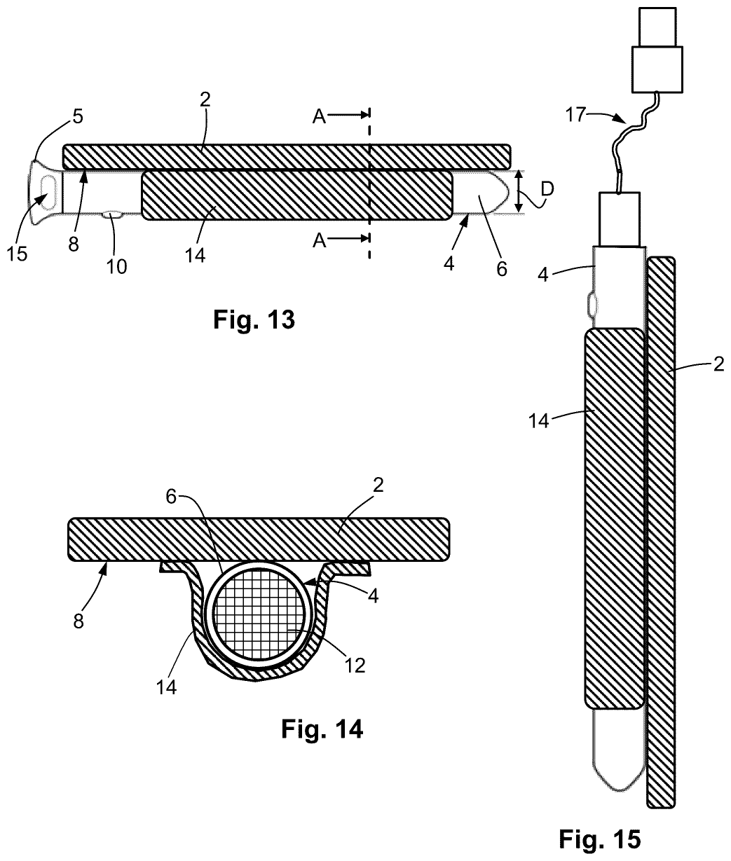

FIG. 11 shows a possible embodiment of the device 1 for stimulation. Vibration unit 4 is detachably held in a force-fitting manner on a rear side 8 (see FIG. 13 and FIG. 14) of design element 2. Design element 2 can be made of an elastic material. This has the advantage that vibration unit 4 can be easily removed from or attached to design element 2 due to the elasticity of the material. The material of design element 2 (holder for vibration unit 4) may preferably be silicone, which is often used for medical devices and products due to its special properties. It is easy to clean and washable and is therefore considered very hygienic.

FIG. 12 shows another possible embodiment of stimulation device 1. In the embodiment shown here, design element 2 has the shape of a feather. Vibration unit 4 is detachably attached to design element 2 in such a way that a head 5 of vibration unit 4 protrudes beyond design element 2 (feather). A chain 3 is attached to head 5 of vibration unit 4, with which stimulation device 1 can be attached by the user 20 to the acupressure point 22 to be stimulated, as shown in FIG. 1. Since vibration unit 4 is detachably connected to design element 2 in a force-fitting manner, it is possible to connect differently designed design elements 2 to vibration unit 4.

The representation of design element 2 in the form of a feather is not to be understood as a limitation of the claims.

FIG. 13 shows a side view of vibration unit 4, which is detachably held on design element 2. A material strip 14 is attached to the rear side 8 of design element 2 in such a way that shaft 6 of vibration unit 4 is held on design element 2 in a force-fitting yet detachable manner between the rear side 8 of design element 2 and material strip 14. According to a preferred embodiment, material strip 14 is glued to the rear side 8 of design element 2. Material strip 14 is preferably made of the same material as design element 2. Preferably, vibration unit 4 is held in such a way that head 5 protrudes above design element 2 and the push button 10 is accessible to the user 20. An opening 15 is formed in head 5 through which the chain (not shown here) is guided.

FIG. 14 shows a schematic sectional view along the section line A-A shown in FIG. 6. Material strip 14 is attached to the rear side 8 of design element 2 in such a way that shaft 6 with its diameter D (see FIG. 6) rests against the rear side 8 of design element 2 and against material strip 14, thereby holding vibration unit 4 in a force-fitting manner.

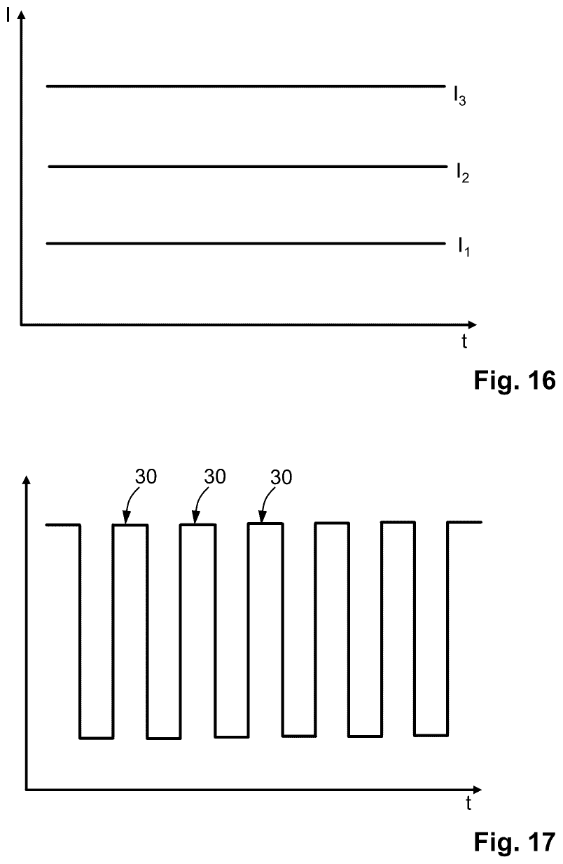

FIG. 16 shows a possible embodiment of the vibration power setting used to stimulate acupressure point 22, in particular CV 17 or the master point. In the embodiment shown here, three power levels I₁, I₂, . . . , I₃ can be set using the at least one push button 10. The setting of three power levels I₁, I₂, . . . , I₃ is merely an example and should not be understood as a limitation of the invention. A plurality of power levels I₁, I₂, . . . , I_{N} can be set with vibration unit 4. Preferably, the power levels I₁, I₂, . . . , I_{N} of vibration unit 4 can be set via the push button 10. According to one possible embodiment, for example, three power levels I₁ (low), I₂ (medium) and I₃ (high) can be set as desired, with at least one vibration frequency being assigned to each power level I₁, I₂, . . . , I₃.

FIG. 17 shows a possible further embodiment of a frequency of the profile for a specific power level I₁, I₂ or I₃ of the vibration with which the stimulation of acupressure point 22 is carried out. In the embodiment shown here, the vibration profile consists of a plurality of rectangular pulses 30 that follow each other in time. The representation of rectangular pulses 30 is only one possible embodiment and should not be understood as a limitation of the invention. It is obvious to a person skilled in the art that the vibration profile may also be a sine or cosine wave or rounded rectangular pulses.

The number of three power levels I₁, I₂ or I₃ used in the description of FIG. 16, which are the frequencies of the vibrations per power level I₁, I₂ or I₃ (profiles assigned to the power levels) that can be set with vibration unit 4, are to be regarded merely as examples for the description and are not to be understood as a limitation of the claims.

It is assumed that the present disclosure and many of the advantages mentioned therein will become apparent from the foregoing description. Various modifications may be made to the form, construction, and arrangement of the components without departing from the disclosed subject matter. The form described is merely explanatory, and it is the intention of the accompanying claims to cover and include such changes.

### LIST OF REFERENCE NUMBERS

1 Device
2 Design element
3 Chain
4 Vibration unit
5 Head
6 Shaft
7 Free end
8 Rear side
9 Visual indicator, display
10 Push button
11 Energy storage device
12 Motor
13 Interior
14 Material strip
15 Opening
16 Thread
17 Charging cable
18₁, 18₂, . . . , 18_{N} Section
19 Control electronics unit
20 User
22 Acupressure point
25 LED
27 Visual indicator element, display element
30 Rectangular pulse
D Diameter
L Length
I₁, I₂, . . . , I_{N} Power level

1. A vibration unit for stimulating an acupressure point, comprising:
a cylindrical shaft, defining an interior for accommodating at least an energy storage device and a motor with an electronics control unit;
a detachable head which is attached to the cylindrical shaft by means of a thread and closes the cylindrical shaft opposite a free end;
a push button, provided on the cylindrical shaft of the vibration unit, wherein the push button is for switching on and off and for setting power levels and a vibration frequency of the vibration unit associated with the power levels is provided;
a visual indicator on the shaft of the vibration unit, wherein the visual indicator displays the set power levels and the set associated vibration frequency; and,
a chain attached to the head of the vibration unit for positioning the vibration unit on the acupressure point.

2. The vibration unit according to claim 1, wherein the push button is designed as a rocker switch for switching the power levels and the associated vibration frequency of the vibration unit up and down.

3. The vibration unit according to claim 1, wherein the visual indicator is divided into several sections and each of the sections represents one of the power levels for which the same but different vibration frequencies can be set.

4. The vibration unit according to claim 1, wherein the detached head allows access of a charging cable which is connectable to the energy storage device in the shaft of the vibration unit.

5. The vibration unit according to claim 1, wherein at least the shaft of the vibration unit and the head are made of stainless steel with a nickel-free outer coating.

6. The vibration unit according to claim 1, wherein a design element consists of an elastic material and is attached in a detachable and force-fitting manner to the cylindrical shaft of the vibration unit by means of an elastic material strip.

7. The vibration unit according to claim 6, wherein the attached design element is positioned on the cylindrical shaft in such a way that the push button is accessible and the visual indicator is readable.

8. The vibration unit according to claim 6, wherein the elastic material strip is attached to a rear side of the design element to hold the vibration unit on the rear side of the design element in a detachable and force-fitting manner.

9. The vibration unit according to claim 8, wherein a material of the design element and a material of the at least one material strip are identical.

10. The vibration unit according to claim 9, wherein the material of the design element and the material of the material strip are washable and consists of silicone.
